(19) United States
(12) Patent Application Publication
(10) Pub. No.: US 2026/0024943 A1
(43) Pub. Date: Jan. 22, 2026

(54) SHIELD RECEIVING MEMBER AND SHIELD CONNECTOR

(71) Applicant: SUMITOMO WIRING SYSTEMS, LTD., Mie (JP)

(72) Inventors: Long CHEN, Mie (JP); Hidekazu MATSUDA, Mie (JP)

(21) Appl. No.: 18/994,609

(22) PCT Filed: Jun. 29, 2023
(86) PCT No.: PCT/JP2023/024151

§ 371 Date: Jan. 15, 2025

(30) Foreign Application Priority Data
Jul. 20, 2022 (JP) 2022-115241

(51) Int. Cl. H01R 13/58; H01R 13/02; H01R 13/502; H01R 13/516

(52) U.S. Cl. CPC H01R 13/5808; H01R 13/025; H01R 13/502; H01R 13/516

(57) ABSTRACT

A shield receiving member includes a body part that extends in a circumferential direction and in which two end portions in the circumferential direction face each other. One of the two end portions of the body part in the circumferential direction has a recess that is recessed in the circumferential direction, and the other of the two end portions has a protrusion that protrudes in the circumferential direction and is disposed inside the recess. The body part has a first locking portion and a second locking portion that are bent from the outer circumferential surface side to the inner circumferential surface side, the first locking portion and the second locking portion extend in the circumferential direction from one end to the other end, respectively, and are arranged side-by-side in an axial direction intersecting the circumferential direction.

### TECHNICAL FIELD

The present disclosure relates to a shield receiving member and a shield connector.

### BACKGROUND

A connector disclosed in Patent Document 1 includes a shield receiving member (referred to as a connection portion in Patent Document 1) that is in contact with a shield (referred to as a shield wire in Patent Document 1) of a shielded wire. The shield receiving member sandwiches the shield between the shield receiving member and a crimping member, and receives a fastening force of the crimping member. The shield receiving member has a tubular shape, and its outer peripheral surface has recesses. The shield enters the recesses by crimping the crimping member. Note that this type of shield receiving member is also disclosed in Patent Documents 2 to 6.

### PRIOR ART DOCUMENT

### Patent Document

Patent Document 1: JP 2008-066149 A

Patent Document 2: JP 2008-282556 A

Patent Document 3: JP 2010-182632 A

Patent Document 4: JP 2014-137941 A

Patent Document 5: JP 2014-154530 A

Patent Document 6: JP 2020-140788 A

### SUMMARY OF THE INVENTION

### Problems to be Solved

In Patent Document 1, if the shield receiving member is not continuous around the entire circumference and is bent such that two end portions in the circumferential direction face each other, there is a concern that a recess may be largely disconnected in the circumferential direction between the two end portions in the circumferential direction. If the recess is thus largely disconnected, then there is a risk that expected improvement in wire holding force due to the shield entering the recess will not be achieved.

In view of this, an object of the present disclosure is to provide a shield receiving member and a shield connector that can improve a wire holding force.

### Means to Solve the Problem

A shield receiving member according to the present disclosure includes a plate-shaped body part that extends in a circumferential direction and in which two end portions in the circumferential direction face each other, in which the body part has an outer circumferential surface that is in contact with a shield of a wire and an inner circumferential surface that is in contact with an outer sheath of the wire, one of the two end portions of the body part in the circumferential direction has a recess that is recessed in the circumferential direction, and the other of the two end portions has a protrusion that protrudes in the circumferential direction and is disposed inside the recess, the body part has a first locking portion and a second locking portion that are bent from an outer circumferential surface side to an inner circumferential surface side, the first locking portion and the second locking portion each extend in the circumferential direction from one end at the one end portion to another end at the other end portion, and are arranged side-by-side in an axial direction intersecting the circumferential direction, one end of the first locking portion is located on a bottom side of the recess, another end of the first locking portion is located on a leading end side of the protrusion, one end of the second locking portion is located closer to one of opening ends of the recess than the one end of the first locking portion, and another end of the second locking portion is located closer to one of base ends of the protrusion than the other end of the first locking portion.

### Effect of the Invention

According to the present disclosure, it is possible to provide a shield receiving member that can improve a wire holding force.

### BRIEF DESCRIPTION OF THE DRAWINGS

FIG. 1 is an exploded perspective view of a shield connector according to Embodiment 1 of the present disclosure.

FIG. 2 is a cross-sectional view of the shield connector.

FIG. 3 is an enlarged cross-sectional view showing a contact portion between a shield receiving member and a shield in FIG. 2.

FIG. 4 is a plan view showing a state in which the shield receiving member is disposed on an outer peripheral side of an outer sheath, before a leading end portion of the shield is folded back to the outer peripheral side of the shield receiving member.

FIG. 5 is a spread-out view of the shield receiving member.

FIG. 6 is an expanded plan view showing two end portions of the shield receiving member in a circumferential direction.

### DETAILED DESCRIPTION TO EXECUTE THE INVENTION

### Description of Embodiments of the Present Disclosure

First, embodiments of the present disclosure will be listed and described.

(1) A shield receiving member according to the present disclosure is a shield receiving member including a plate-shaped body part that extends in a circumferential direction and in which two end portions in the circumferential direction face each other, in which the body part has an outer circumferential surface that is in contact with a shield of a wire and an inner circumferential surface that is in contact with an outer sheath of the wire, one of the two end portions of the body part in the circumferential direction has a recess that is recessed in the circumferential direction, and the other of the two end portions has a protrusion that protrudes in the circumferential direction and is disposed inside the recess, the body part has a first locking portion and a second locking portion that are bent from an outer circumferential surface side to an inner circumferential surface side, the first locking portion and the second locking portion each extend in the circumferential direction from one end at the one end portion to another end at the other end portion, and are arranged side-by-side in an axial direction intersecting the circumferential direction, one end of the first locking portion is located on a bottom side of the recess, another end of the first locking portion is located on a leading end side of the protrusion, one end of the second locking portion is located closer to one of opening ends of the recess than the one end of the first locking portion, and another end of the second locking portion is located closer to one of base ends of the protrusion than the other end of the first locking portion.

With the above configuration, the shield of the wire can enter the first locking portion and the second locking portion. Also, the first locking portion and the second locking portion can engage the outer sheath of the wire. As a result, the shield receiving member can hold the wire.

Further, according to the above-described configuration, when the protrusion is disposed inside the recess between the two end portions of the body part in the circumferential direction, the other end of the first locking portion and one end of the second locking portion can be intermittent or continuous without significant disconnection in the circumferential direction when viewed from the axial direction. Therefore, the above configuration can reduce or eliminate discontinuity in wire holding force between the two end portions of the body part in the axial direction, thereby improving the wire holding force.

(2) It is preferable that the second locking portions are disposed on both sides of the first locking portion in the axial direction.

With the above configuration, the first locking portion and the second locking portions can hold the wire firmly and stably.

(3) The second locking portions each preferably have a flat surface extending along the axial direction on the inner circumferential surface side, and the first locking portion preferably has a pointed or curved protruding surface on the inner circumferential surface side.

With the above configuration, because the shield is likely to enter the second locking portions and the second locking portions are disposed on both sides of the first locking portion in the axial direction, the shield is stably held by the second locking portions. Further, since the protruding surface of the first locking portion can firmly engage the outer sheath, displacement of the outer sheath (wire) relative to the shield receiving member is restricted.

(4) A width of the first locking portion in the axial direction is preferably smaller than a width of the second locking portions in the axial direction.

With the above configuration, even when the size of the body part is reduced in the axial direction, a sufficient separation can be secured between the first locking portion and the second locking portions within the width of the body part in the axial direction, resulting in high space efficiency.

(5) It is preferable that the recess has a bottom at a central portion in the axial direction at the one end portion of the body part, has the opening ends at both end portions in the axial direction at the one end portion of the body part, and has a shape such that an inclined recess face connects the bottom and the opening end, the protrusion has a leading end at a central portion in the axial direction at the other end portion of the body part, has the base ends at both end portions in the axial direction at the other end portion of the body part, and has a shape such that an inclined protrusion face connects the leading end and the base ends, and the one end of each of the second locking portions overlaps the inclined recess face when viewed from the axial direction, and the other end of the second locking portion overlaps the inclined protrusion face when viewed from the axial direction.

With the above configuration, the first locking portion and the second locking portions are arranged with high space efficiency within the width of the body part in the axial direction, which can contribute to reducing the size of the body part in the axial direction.

(6) A shield connector preferably includes the shield receiving member according to any one of (1) to (5) above; an inner conductor terminal connected to a core wire of the wire; a dielectric that accommodates the inner conductor terminal; and an outer conductor terminal disposed on an outer peripheral side of the dielectric, in which the outer conductor terminal has a crimping portion that sandwiches and crimps the shield between the outer conductor terminal and the shield receiving member, and the first locking portion and the second locking portion are covered by the crimping portion.

With the above configuration, the shield can receive the fixing force of the crimping portion and enter the first locking portion and the second locking portions, and the first locking portion and the second locking portions can engage the outer sheath. Therefore, even when the size of the body part in the axial direction is reduced, the wire holding force can be improved, which in turn contributes to reducing the size of the outer conductor terminal in the axial direction.

### Details of Embodiments of the Present Disclosure

A specific example of the present disclosure will be described below with reference to the drawings. Note that the present invention is not limited to these examples, and is defined by the claims, and all changes that come within the meaning and range of equivalency of the claims are intended to be embraced therein.

### Embodiment 1

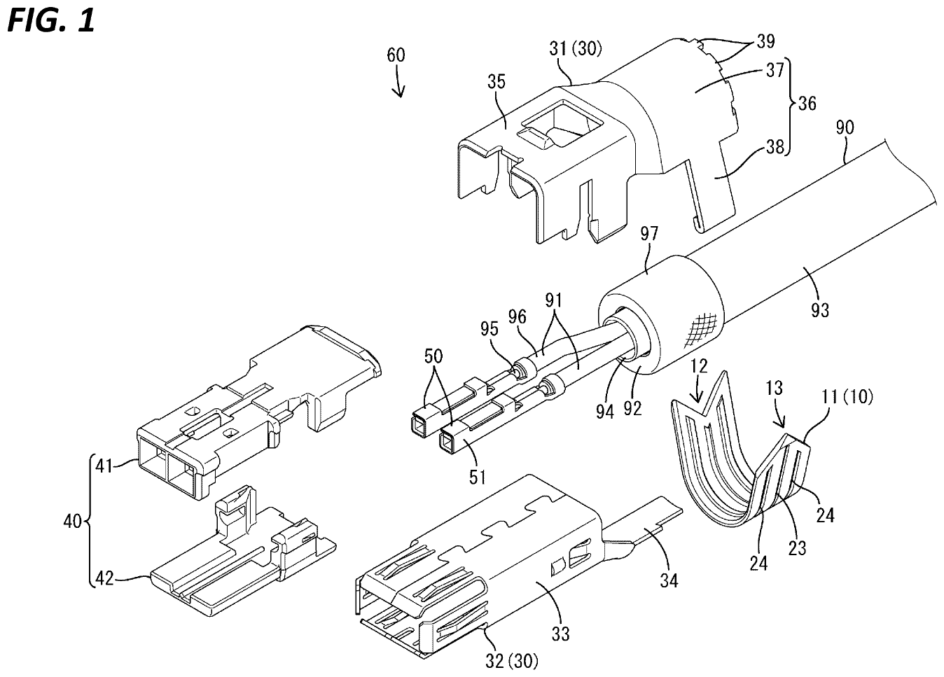

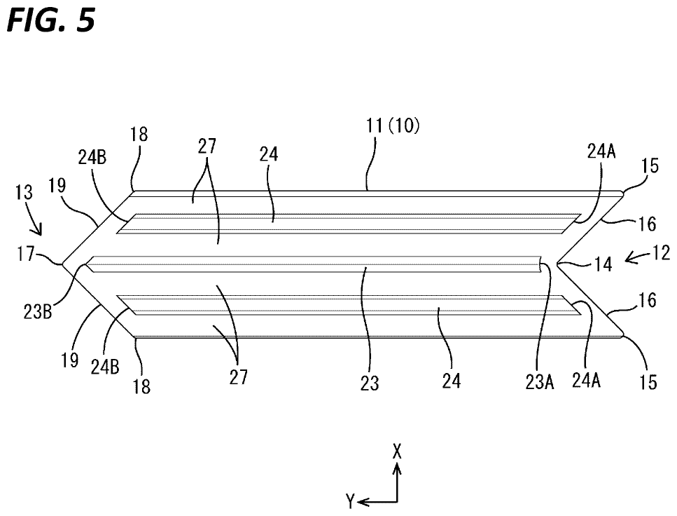

A shield receiving member 10 according to Embodiment 1 of the present disclosure is a tubular member that receives and supports a shield 92 of a wire 90, and is commonly referred to as a “sleeve”. The shield receiving member 10 constitutes a part of the shield connector 60. Note that, in the following description, the left side in the drawings except for FIG. 5 is referred to as the front side in the front-rear direction. The front-rear direction corresponds to a lengthwise direction of the wire 90 and may be referred to as an “axial direction”. The up-down direction is based on the up-down direction shown in FIGS. 1 to 4 and 6. The up-down direction does not necessarily coincide with a vertical direction when the shield connector 60 is mounted in a vehicle or the like. The circumferential direction refers to a direction intersecting (specifically, orthogonal to) the axial direction, and refers to the circumferential direction of the shield receiving member 10, unless otherwise specified. In the drawings, the letter “X” indicates the front-rear direction (axial direction), and the letter “Y” indicates the circumferential direction. An arrow “Y” shown in the drawings corresponds to an upward direction.

### Wire

The wire 90 is a shielded wire, and as shown in FIG. 1, includes a plurality of conductive wires 91, a shield 92 that collectively surrounds the conductive wires 91, and an insulating outer sheath 93 covering an outer periphery of the shield 92. An insulating member 94 is disposed between the conductive wires 91 and the shield 92. In the case of Embodiment 1, two conductive wires 91 are twisted together to constitute a twisted pair wire. Each conductive wire 91 is a covered wire in which a core wire 95 is covered by an insulating sheath 96.

A front end portion of each conductive wire 91 is not covered by the shield 92, the outer sheath 93, or the insulating member 94, and is exposed. At the front end portion of the conductive wire 91, the insulating sheath 96 is stripped away and the core wire 95 is exposed.

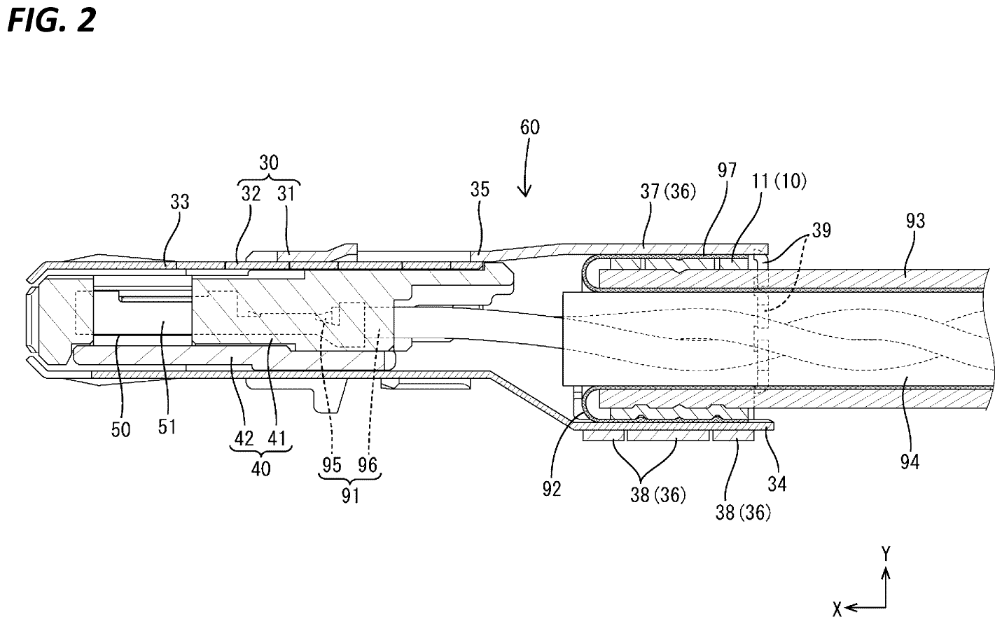

In the case of Embodiment 1, the shield 92 is a braided wire in which conductive bare wires are braided in a tubular shape. A front end portion of the shield 92 is folded back toward the outer periphery of the outer sheath 93 to form a shield leading end portion 97. As shown in FIG. 2, the shield receiving member 10 is interposed between the shield leading end portion 97 and the outer sheath 93.

### Shield Connector

As shown in FIG. 1, the shield connector 60 includes the shield receiving member 10, inner conductor terminals 50, a dielectric 40, and an outer conductor terminal 30. A structure of the shield receiving member 10 will be described later in detail.

The inner conductor terminal 50 is made of a conductive metal, and a pair of inner conductor terminals 50 are respectively provided on the two conductive wires 91.

The inner conductor terminals 50 are electrically connected to the core wires 95 of the conductive wires 91, and mechanically connected to the insulating sheaths 96 of the conductive wires 91, respectively. Also, each inner conductor terminal 50 has a rectangular tubular box portion 51 that is electrically connected to a counterpart inner conductor terminal (not shown).

The dielectric 40 is made of synthetic resin, and is constituted by a first dielectric 41 and a second dielectric 42 that are detachable. The first dielectric 41 is disposed on the upper side of the second dielectric 42, and has cavities (not shown) in which the inner conductor terminals 50 are accommodated, on the left and right sides. The second dielectric 42 is a lid-like member that closes the cavities that are open downward. The dielectric 40 functions to maintain the inner conductor terminals 50 and the outer conductor terminal 30 in an insulated state.

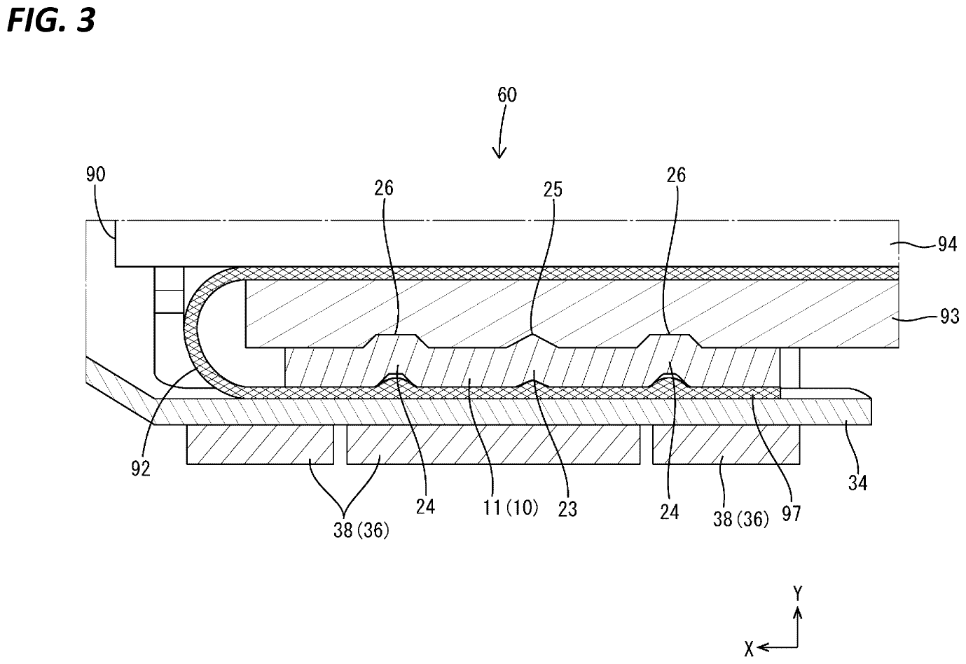

The outer conductor terminal 30 is made of conductive metal, and is constituted by a first outer conductor terminal 31 and a second outer conductor terminal 32 that is disposed below the first outer conductor terminal 31. The second outer conductor terminal 32 has a surrounding portion 33 that surrounds the outer periphery of the dielectric 40, and a band-shaped extension portion 34 that extends rearward from a rear end of a lower wall of the surrounding portion 33. The surrounding portion 33 is electrically connected to a counterpart outer conductor terminal of a counterpart shield connector (not shown). As shown in FIG. 3, the extension portion 34 is disposed on the outer peripheral side of the shield leading end portion 97.

As shown in FIG. 2, the first outer conductor terminal 31 has an attachment portion 35 attached to a rear portion of the second outer conductor terminal 32, and a crimping portion 36 that is continuous with the rear of the attachment portion 35. The crimping portion 36 has a base 37 that extends continuously from the attachment portion 35, and a plurality of barrel pieces 38 that protrude from both the left and right sides of the base 37. As shown in FIG. 3, three barrel pieces 38 at the left and right ends of the base 37 are arranged alternately in the front-rear direction. The crimping portion 36 is bent into a cylindrical shape during a crimping process. Each barrel piece 38 is wound around the outer peripheral surfaces of the shield leading end portion 97 and the extension portion 34 during the crimping process.

As shown in FIG. 1, a plurality of claws 39 are arranged side-by-side in the circumferential direction at the rear end of the crimping portion 36. As shown in FIG. 2, the claws 39 are bent inward in the radial direction from the rear end of the base 37, and face the shield receiving member 10 from the rear. The claws 39 keep the shield receiving member 10 from coming off rearward from the outer conductor terminal 30.

### Shield Receiving Member

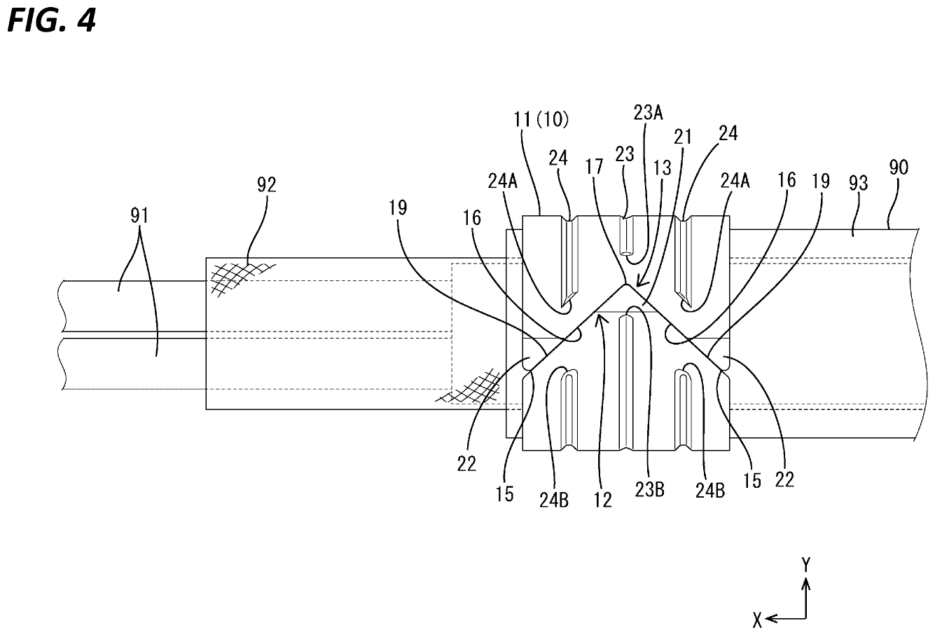

The shield receiving member 10 is made of conductive metal, and has a body part 11 (see FIG. 4), which is bent in a cylindrical shape. The body part 11 has a band shape, and has a constant width in the front-rear direction. One of the two end portions of the body part 11 in the circumferential direction (in the left-right lengthwise direction when unfolded) has a recess 12 that has a triangular recessed shape when viewed from the radial direction, and the other of the two end portions has a protrusion 13 that has a triangular protruding shape when viewed from the radial direction. That is, the recess 12 is recessed in the circumferential direction at one end portion of the body part 11, and the protrusion 13 protrudes in the circumferential direction at the other end portion of the body part 11. The recess 12 and the protrusion 13 are fittable to each other.

As shown in FIG. 4, in a state in which the body part 11 is bent in a cylindrical shape, the two end portions in the circumferential direction face each other, and the protrusion 13 is disposed inside the recess 12. As shown in FIG. 3, the inner circumferential surface of the body part 11 is disposed along the outer sheath 93 of the wire 90, and can be in contact with the outer sheath 93. The outer circumferential surface of the body part 11 is disposed along the shield leading end portion 97 of the wire 90, and can be in contact with the shield leading end portion 97.

As shown in FIG. 5, the recess 12 has a bottom 14 at a central portion in the width direction at the one end portion of the body part 11, and has opening ends 15 at both ends in the width direction at the one end portion of the body part 11. Also, the recess 12 has a pair of inclined recess faces 16 that extend in a tapered shape respectively from the opening ends 15 to the bottom 14.

The protrusion 13 has a leading end 17 at a central portion in the width direction at the other end portion of the body part 11, and has base ends 18 at both ends in the width direction at the other end portion of the body part 11. Also, the protrusion 13 has a pair of inclined protrusion faces 19 that extend in a tapered shape respectively from the base ends 18 to the leading end 17. The opening angle of the inclined protrusion faces 19 and the opening angle of the inclined recess faces 16 are set to be the same.

As shown in FIG. 4, the body part 11 has a leading end striking surface 21 on the outer peripheral surface of the protrusion 13 on the leading end 17 side, the leading end striking surface 21 being inclined in a direction in which the thickness decreases toward the leading end 17. Also, the body part 11 has an opening end striking surface 22 on the outer peripheral surface of the recess 12 on each opening end 15 side, the opening end striking surface 22 being inclined in a direction in which the thickness decreases toward the opening end 15. Since the body part 11 has the opening end striking surfaces 22 and the leading end striking surface 21, an elastic reaction force is suppressed at one end portion and the other end portion of the body part 11, and the tubular shape of the body part 11 can be easily maintained.

The body part 11 has a first locking portion 23 and a second locking portions 24 that are arranged side-by-side in the front-rear direction. A pair of the second locking portions 24 are arranged on the body part 11 on the respective front and rear sides of the first locking portion 23.

The first locking portion 23 extends in the circumferential direction, and as shown in FIG. 3, has a serration shape (rib shape) that is bent from the outer circumferential surface side to the inner circumferential surface side (inward in the radial direction) of the body part 11. As shown in FIG. 5, the first locking portion 23 has one end 23A as a closed end at a position close to the bottom 14 of the recess 12 on the one end portion side of the body part 11 in the circumferential direction. As shown in FIG. 4, one end 23A of the first locking portion 23 is disposed on the outer circumferential surface of the body part 11 adjacent to the leading end striking surface 21 in the circumferential direction.

The first locking portion 23 has another end 23B as a closed end at a position close to the leading end 17 of the protrusion 13 on the other end portion side of the body part 11 in the circumferential direction. As shown in FIG. 5, the other end 23B of the first locking portion 23 has a triangular protruding shape when viewed from the radial direction to correspond to the leading end 17 of the protrusion 13 on the inner circumferential surface side of the body part 11. The first locking portion 23 extends seamlessly and continuously in the circumferential direction from one end 23A to the other end 23B. As shown in FIG. 3, the first locking portion 23 has a triangular (V-shaped) cross section, and has a protruding surface 25 that sharply protrudes inward in the radial direction on the inner circumferential surface of the body part 11.

Similar to the first locking portion 23, the second locking portions 24 extend in the circumferential direction, and as shown in FIG. 3, has a serration shape (rib shape) that is bent from the outer circumferential surface side to the inner circumferential surface side of the body part 11. As shown in FIG. 5, each second locking portion 24 has one end 24A as a closed end at a position closer to the opening end 15 of the recess 12 on the one end portion side of the body part 11 than one end 23A of the first locking portion 23. As shown in FIG. 4, one end 24A of the second locking portion 24 overlaps the inclined recess face 16 when viewed from the axial direction (front-rear direction).

As shown in FIG. 5, each second locking portion 24 has another end 24B as a closed end at a position closer to the base end 18 of the protrusion 13 on the other end portion side of the body part 11 than the other end 23B of the first locking portion 23. As shown in FIG. 4, the other end 24B of the second locking portion 24 overlaps the inclined protrusion faces 19 when viewed from the axial direction. As shown in FIG. 5, on the inner circumferential surface of the body part 11, one end 24A and the other end 24B of the second locking portion 24 are inclined with respect to the front-rear direction so as to be parallel to the inclined recess face 16 and the inclined protrusion face 19, respectively. The second locking portion 24 extends seamlessly and continuously in the circumferential direction from one end 24A to the other end 24B. As shown in FIG. 3, the second locking portion 24 has a trapezoidal (rectangular U-shaped) cross section, and has a flat surface 26 that is horizontal along the front-rear direction on the inner circumferential surface of the body part 11.

As shown in FIG. 5, the front-rear width of the first locking portion 23 is set to be smaller than the front-rear width of each second locking portion 24. Within the front-rear width of the body part 11, separation spaces 27 with a front-rear width that is uniform or substantially uniform and exceeds the front-rear width of the second locking portion 24 are present between the first locking portion 23 and the second locking portions 24, and between the front and rear end portions of the body part 11 and the second locking portion 24.

### Functions of Shield Receiving Member and Shield Connector

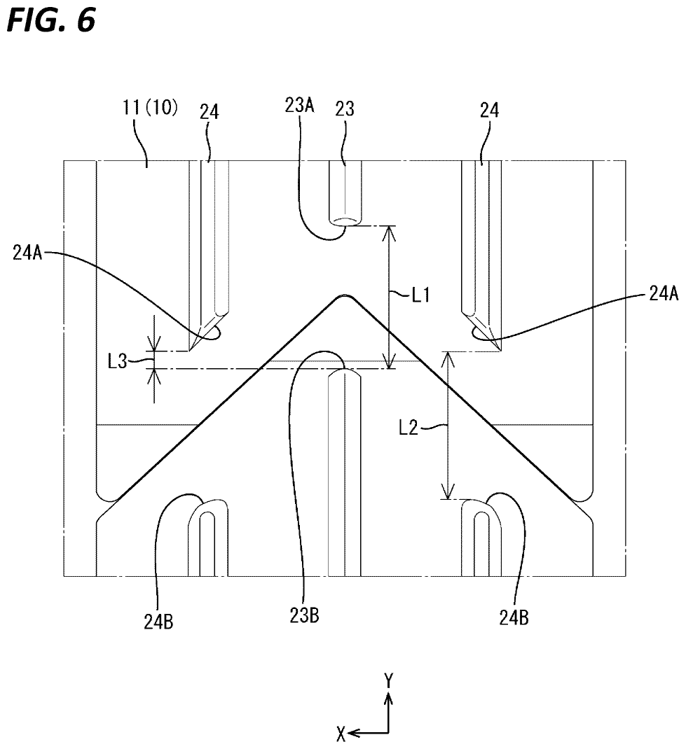

When the shield connector 60 is to be attached, the body part 11 of the shield receiving member 10 is disposed on the outer peripheral side of the outer sheath 93 as shown in FIG. 4. The body part 11 is bent into a tubular shape, and disposed such that the protrusion 13 fits into the recess 12. In the tubular body part 11, the bottom 14 of the recess 12 and the leading end 17 of the protrusion 13 face each other to abut against each other, and the inclined recess faces 16 and the inclined protrusion faces 19 are in contact with each other along an oblique direction intersecting the axial direction. As shown in FIG. 6, one end 23A and the other end 23B of the first locking portion 23 are spaced apart from each other in the circumferential direction by a distance L1. Also, one end 24A and the other end 24B of the second locking portion 24 are spaced apart from each other in the circumferential direction by a distance L2. On the other hand, the other end 23B of the first locking portion 23 and one end 24A of the second locking portion 24 are disposed at a distance L3, which is sufficiently smaller than the distances L1 and L2, in the circumferential direction when viewed from the axial direction.

A front end portion of the shield 92 is folded back in the state shown in FIG. 4, and the shield leading end portion 97 is disposed on the outer circumferential surface of the body part 11. The crimping portion 36 of the first outer conductor terminal 31 is crimped to the outer peripheral surface of the shield leading end portion 97. As shown in FIG. 3, on the lower end side of the shield connector 60, the extension portion 34 of the second outer conductor terminal 32 is disposed on the outer peripheral surface of the shield leading end portion 97, and the barrel pieces 38 of the crimping portion 36 are crimped to the outer peripheral surface of the extension portion 34.

As shown in FIG. 3, the shield leading end portion 97 crimped to the crimping portion 36 enters the recesses of the first locking portion 23 and the second locking portions 24 that are open in the outer circumferential surface of the body part 11. In particular, each second locking portion 24 has a larger opening width than the first locking portion 23, corresponding to the front-rear width of the flat surface 26, and thus the shield leading end portion 97 can enter the recess by a larger amount. Thus, even if a rearward tensile force or the like is applied to the shield leading end portion 97, the shield leading end portion 97 is kept from coming off from between the crimping portion 36 and the shield receiving member 10.

Also, the protruding surface 25 of the first locking portion 23 and the flat surfaces 26 of the second locking portions 24 engage the outer sheath 93 of the wire 90. In particular, the protruding surface 25 of the first locking portion 23 disposed at the central portion of the body part 11 in the front-rear direction can firmly engage the outer sheath 93 due to its protruding shape. Thus, even if a rearward tensile force or the like is applied to the outer sheath 93, the outer sheath 93 (wire 90) is kept from coming off from the inside of the body part 11.

As described above, when viewed from the axial direction in a state in which the body part 11 is bent in a tubular shape and the protrusion 13 is disposed inside the recess 12, a circumferential distance L3 between the other end 23B of the first locking portion 23 and one end 24A of the second locking portion 24 is sufficiently smaller than each of the distance L1 between both end portions of the first locking portion 23 in the circumferential direction and the distance L2 between both end portions of the second locking portion 24 in the circumferential direction (see FIG. 6). Thus, the serration shape formed by the first locking portion 23 and the second locking portions 24 is intermittent in the circumferential direction as a whole, but appears continuous without significant disconnection.

Since the above serration shape is formed almost continuously in the circumferential direction, even if a gap is present between the inclined recess faces 16 of the recess 12 and the inclined protrusion faces 19 of the protrusion 13, the wire 90 can be reliably kept from coming off from the shield connector 60, and wire holding force can be improved.

Also, according to Embodiment 1, a pair of the second locking portions 24 are arranged on the respective front and rear sides of the first locking portion 23, and thus the wire 90 can be firmly and stably held.

Since each second locking portion 24 has the flat surface 26 extending along the front-rear direction on its inner circumferential surface, the shield leading end portion 97 is stably held by the second locking portion 24. Since the first locking portion 23 has a pointed protruding surface 25 on the inner circumferential surface and the protruding surface 25 can engage the outer sheath 93, displacement of the outer sheath 93 (wire 90) relative to the shield receiving member 10 is reliably restricted.

Since the front-rear width of the first locking portion 23 is smaller than the front-rear width of each second locking portion 24, even when the front-rear width of the body part 11 is reduced, sufficient separation spaces 27 can be secured within the front-rear width of the body part 11.

Further, since the other end 23B of the first locking portion 23 overlaps the inclined protrusion faces 19 when viewed from the axial direction and one end 24A of each second locking portion 24 overlaps the inclined recess faces 16 when viewed from the axial direction, the first locking portion 23 and the second locking portions 24 are arranged within the front-rear width of the body part 11 in a space efficient manner, which contributes to reducing the size of the body part 11. If the size of the body part 11 can be reduced, the size of the first outer conductor terminal 31 can be also reduced, which can reduce a material cost and provide excellent versatility.

### Other Embodiments of the Present Disclosure

Embodiment 1 disclosed above in this application is to be considered in all respects as illustrative and not restrictive.

In the case of Embodiment 1, one first locking portion is disposed at the central portion of the body part in the front-rear direction. In contrast, according to other embodiments, a plurality of first locking portions may be disposed at the central portion of the body part in the front-rear direction.

In the case of Embodiment 1, a pair of second locking portions are disposed on the body part on the respective front and rear sides of the first locking portion. In contrast to this, according to other embodiments, a plurality of pairs of second locking portions may be arranged on the body part on the respective front and rear sides of the first locking portion.

In the case of Embodiment 1 above, the protrusion has a triangular protruding shape when viewed from the radial direction, and the recess has a triangular recessed shape when viewed from the radial direction. In contrast to this, according to other embodiments, the protrusion may have a rectangular protruding shape or curved protruding shape when viewed from the radial direction, and the recess may have a rectangular recessed shape or curved recessed shape when viewed from the radial direction.

In the case of Embodiment 1 above, the protruding surface of the protrusion has a pointed shape. In contrast to this, according to other embodiments, the protruding surface of the protrusion may have a curved shape.

In the case of Embodiment 1, one recess is disposed at one end portion of the body part, and the protrusion is disposed at the other end portion of the body part. In contrast to this, according to other embodiments, a plurality of recesses may be disposed side-by-side at one end portion of the body part, and a plurality of protrusions may be arranged side-by-side at the other end portion of the body part.

In the case of Embodiment 1, there is the circumferential distance L3 between the other end of the first locking portion and one end of the second locking portion. In contrast to this, according to other embodiments, a configuration may be adopted in which there is no distance L3 mentioned above, and the other end portion of the first locking portion and one end portion of the second locking portion overlap each other when viewed from the axial direction.

### LIST OF REFERENCE NUMERALS

10 Shield receiving member
11 Body
12 Recess
13 Protrusion
14 Bottom
15 Opening end
16 Inclined recess face
17 Leading end
18 Base end
19 Inclined protrusion face
21 Leading end striking portion
22 Opening end striking portion
23 First locking portion
23A One end of first locking portion
23B Another end of first locking portion
24 Second locking portion
24A One end of second locking portion
24B Another end of second locking portion
25 Protruding surface
26 Flat surface
27 Separation space
30 Outer conductor terminal
31 First outer conductor terminal
32 Second outer conductor terminal
33 Surrounding portion
34 Extension portion
35 Attachment portion
36 Crimping portion
37 Base
38 Barrel piece
39 Claw
40 Dielectric
41 First dielectric
42 Second dielectric
50 Inner conductor terminal
51 Box portion
60 Shield connector
90 Wire
91 Conductive wire
92 Shield
93 Outer sheath
94 Insulating member
95 Core wire
96 Insulating sheath
97 Shield leading end portion
L1 Circumferential distance between one end and another end of first locking portion
L2 Circumferential distance between one end and another end of second locking portion
L3 Circumferential distance between another end of first locking portion and one end of second locking portion

1. A shield receiving member comprising
a plate-shaped body part that extends in a circumferential direction and in which two end portions in the circumferential direction face each other,
wherein the body part has an outer circumferential surface that is in contact with a shield of a wire and an inner circumferential surface that is in contact with an outer sheath of the wire,
one of the two end portions of the body part in the circumferential direction has a recess that is recessed in the circumferential direction, and the other of the two end portions has a protrusion that protrudes in the circumferential direction and is disposed inside the recess,
the body part has a first locking portion and a second locking portion that are bent from an outer circumferential surface side to an inner circumferential surface side,
the first locking portion and the second locking portion each extend in the circumferential direction from one end at the one end portion to another end at the other end portion, and are arranged side-by-side in an axial direction intersecting the circumferential direction,
one end of the first locking portion is located on a bottom side of the recess,
another end of the first locking portion is located on a leading end side of the protrusion,
one end of the second locking portion is located closer to one of opening ends of the recess than the one end of the first locking portion, and
another end of the second locking portion is located closer to one of base ends of the protrusion than the other end of the first locking portion.

2. The shield receiving member according to claim 1,
wherein the second locking portions are disposed on both sides of the first locking portion in the axial direction.

3. The shield receiving member according to claim 2,
wherein the second locking portions each have a flat surface extending along the axial direction on the inner circumferential surface side, and the first locking portion has a pointed or curved protruding surface on the inner circumferential surface side.

4. The shield receiving member according to claim 3,
wherein a width of the first locking portion in the axial direction is smaller than a width of the second locking portions in the axial direction.

5. The shield receiving member according to claim 2,
wherein the recess has a bottom at a central portion in the axial direction at the one end portion of the body part, has the opening ends at both end portions in the axial direction at the one end portion of the body part, and has a shape such that an inclined recess face connects the bottom and the opening ends,
the protrusion has a leading end at a central portion in the axial direction at the other end portion of the body part, has the base ends at both end portions in the axial direction at the other end portion of the body part, and has a shape such that an inclined protrusion face connects the leading end and the base ends, and
the one end of each of the second locking portions overlaps the inclined recess face when viewed from the axial direction, and the other end of the second locking portion overlaps the inclined protrusion face when viewed from the axial direction.

6. A shield connector comprising:
the shield receiving member according to claim 1;
an inner conductor terminal connected to a core wire of the wire;
a dielectric that accommodates the inner conductor terminal; and
an outer conductor terminal disposed on an outer peripheral side of the dielectric,
wherein the outer conductor terminal has a crimping portion that sandwiches and crimps the shield between the outer conductor terminal and the shield receiving member, and
the first locking portion and the second locking portion are covered by the crimping portion.
